(19) United States
(12) Patent Application Publication
(10) Pub. No.: US 2025/0325097 A1
(43) Pub. Date: Oct. 23, 2025

(54) METHOD FOR SEPARATING BRISTLE BUNDLES, SEPARATING DEVICE, AND BRUSH-FILING MACHINE

(71) Applicant: Zahoransky AG, Todtnau (DE)

(72) Inventor: Robert STEINEBRUNNER, Todtnau (DE)

(73) Assignee: Zahoransky AG, Todtnau (DE)

(21) Appl. No.: 18/868,265

(22) PCT Filed: Dec. 12, 2023
(86) PCT No.: PCT/EP2023/085425

§ 371 Date: Nov. 22, 2024

(30) Foreign Application Priority Data
Jan. 16, 2023 (DE) 10 2023 100 859.5

(51) Int. Cl. A46D 1/08; A46D 3/04; A46D 3/08; F16H 37/12

(52) U.S. Cl. CPC A46D 1/08; A46D 3/04; A46D 3/082; F16H 37/122

(57) ABSTRACT

A method for separating bristle bundles (5) from a supply (10) of loose bristle filaments (11) is provided, in which a bundle separator (13) having a separating notch (14) is moved in a separating movement past the supply (10) of loose bristle filaments (11), in the process separating a bristle bundle (5) from the supply (10) which makes its way into the separating notch (14). When the separating movement is carried out, the separating notch (14) changes its direction of movement in a separating region (16) on the supply (10) at least twice, preferably at least thrice.

### CROSS-REFERENCE TO RELATED APPLICATIONS

This application is a 371 National Phase of PCT/EP2023//085425, filed Dec. 12, 2023, which claims priority from German Patent Application No. 10 2023 100 859.5, filed Jan. 16, 2023, both of which are incorporated herein by reference as if fully set forth.

### TECHNICAL FIELD

The invention relates to a method for separating bristle bundles from a supply of loose bristle filaments, wherein a bundle separator having a separating notch is moved in a separating movement past the supply of loose bristle filaments, a bristle bundle is separated from the supply in the process, and the bristle bundle makes its way into the separating notch.

Furthermore, the invention also relates to a separating device for separating bristle bundles from a supply of loose bristle filaments. The device can be specified for carrying out the above-mentioned method. Furthermore, a brush filling machine having a separating device of this type is also proposed.

### BACKGROUND

Bristle bundles are required for manufacturing brushes, for example toothbrushes. The bristle bundles can be separated from a supply of loose bristle filaments by way of a bundle separator of a separating device. For this purpose, the bundle separator can be moved in a separating movement past the supply of loose bristle filaments. In the process, a separating notch which is formed on the bundle separator is moved through a separating region on the supply of loose bristle filaments, as a result of which bristle filaments make their way into the separating notch and are then present as a bristle bundle in the latter.

With the aid of the bundle separator, the separated bristle bundle can subsequently be fed to a filling tool of a brush filling machine. The filling tool can then retrieve the bristle bundle from the separating notch and fill said bundle into a receptacle hole of a brush body that has been offered up.

When separating bristle bundles from a supply of loose bristle filaments it is an objective to separate bristle bundles with a number of bristle filaments which is as constant as possible. The number of bristle filaments that are combined in a bristle bundle is determined by the shape and size of the separating notch and can influence the performance characteristics of the bristle bundle. Therefore, the separating notch should be ideally completely filled with bristle filaments in each separating procedure. This makes it possible to provide bristle bundles which have an identical or only slightly varying number of bristle filaments.

### SUMMARY

It is thus an object of the invention to provide a method for separating bristle bundles, a separating device for separating bristle bundles, and a brush filling machine of the type mentioned at the outset which facilitate reliable and consistent filling of the separating notch with bristle filaments.

In order to achieve the object, a method for separating bristle bundles from a supply of loose bristle filaments is firstly proposed, which has one or more of the means and features disclosed herein directed toward a method of this type. Thus, in order to achieve this object, a method for separating bristle bundles from a supply of loose bristle filaments is in particular proposed, wherein a bundle separator having a separating notch is moved in a separating movement past the supply of loose bristle filaments, in the process a bristle bundle being separated from the supply and making its way into the separating notch, wherein, when the separating movement is carried out, the separating notch changes its direction of movement in a separating region on the supply at least twice, preferably at least thrice. The filling of the separating notch can be facilitated by changing the direction of movement of the separating notch when separating bristle bundles from the supply of loose bristle filaments in the separating region. When separating bristle bundles from the supply of loose bristle filaments, an edge which is a rear edge in the direction of movement of the separating notch while carrying out the separating movement and which delimits the separating notch can play an important part. Bristle filaments which face the separating notch in the separating region come into contact with this rear edge when the separating movement is carried out, and are directed into the separating notch by way of this rear edge. The filling of the separating notch thus is at least partially performed by way of this edge of the separating notch that is in each case the rear edge in the direction of movement of the separating notch. By changing the direction of movement of the separating notch when carrying out the separating movement in the separating region on the supply of loose bristle filaments, the separating notch can be filled with bristle filaments multiple times from different directions. This facilitates a distribution of bristle filaments in the separating notch. As a result of the separating notch changing its direction of movement at least twice, preferably at least thrice, according to the invention when the separating movement is carried out in a separating region, the separating notch can thus be filled particularly reliably and ideally completely with bristle filaments.

An even number of changes of direction of the separating notch when carrying out the separating movement in the separating region enables the separating notch to be moved into the separating region on one side of the separating region, and to be removed from the separating region on another side of the separating region.

In the case of an odd number of changes of direction, the separating notch can be removed from the separating region by way of the side by way of which the separating notch has previously been moved into the separating region.

In one embodiment of the method, when the separating movement is carried out, the separating notch can pass at least two, preferably at least three, reversal points which are disposed in the separating region on the supply of loose bristle filaments. The reversal points herein can be disposed at different positions in the separating region, for example. The separating movement in which the separating notch is moved through the separating region on the supply of loose bristle filaments can have a sinusoidal or sinus-shaped profile.

When the separating notch passes at least two, preferably at least three, reversal points when the separating movement is carried out in the separating region, it is possible to design the separating region on the supply of loose bristle filaments so as to be smaller without however reducing the dwell time of the separating notch in the separating region on the supply of loose bristle filaments. The dwell time of the separating notch in the separating region when the separating movement is carried out can likewise influence the filling of the separating notch with bristle filaments. In this way, the method overall enables a reduction in the dimensions of the separating region and thus a reduction in the space requirement for a bristle magazine in which the bristle filaments of the supply of loose bristle filaments can be stored.

It is possible in this way to provide a separating device of which the bristle magazine can be of a more compact design. A separating device, and also a brush filling machine having such a separating device, which overall require a smaller space, or the bristle magazines of which can have a larger number of material ducts for storing, for example, different types of bristle filaments, can thus be provided.

In one embodiment of the method it is provided that, when the separating movement is carried out in the separating region, the separating notch passes at least two rear reversal points which face away from a filling tool. These rear reversal points can be disposed at different positions in the separating region on the supply. As a result of the at least two rear reversal points, bristle filaments can be picked at different positions in the separating region. This can also facilitate the filling of the separating notch with bristle filaments.

In one embodiment of the method, the separating movement of the separating notch can be generated by superimposing at least two movements. These at least two movements can be, for example, sinusoidal and/or have different amplitudes. It is also possible to combine the separating movement from at least two movements which are carried out successively. Here too, the movements can be, for example, sinusoidal and/or have different amplitudes.

A first movement of the at least two movements can be a main movement of the separating notch, by way of which the separating notch is moved between a filling tool and the supply of loose bristle filaments.

The second movement of the at least two movements can be an additional movement of the separating notch, which the separating notch, in particular the bundle separator on which the separating notch is disposed, carries out within the separating region on the supply.

The main movement can be caused by a drive motor, in particular by an output shaft of the drive motor, of a separating device and/or a brush filling machine. The additional movement can be caused by an actuator, for example by a piezo element. The actuator can be disposed in the force flux between the bundle separator, on which the separating notch is formed, and a drive motor for the bundle separator, for example.

In one embodiment of the method and also of the separating device which will be described in more detail hereunder, the actuator can be specified to adjust the length of a drive linkage by way of which the bundle separator can be at least indirectly connected to the drive motor.

In this way, the additional movement of the separating notch can be caused by a length adjustment of this drive linkage effected by the actuator, and if required be superimposed on the main movement of the bundle separator and its separating notch.

In one embodiment of the method it is provided that the frequency and/or the amplitude of the additional movement and/or of the main movement is predefined by a preferably programmable controller which can be specified for activating the actuator and/or the drive motor. If required, the frequency and/or the amplitude of the additional movement and/or of the main movement can also be modified by the controller. In this way, it is easily possible to adapt the method to a modified production program.

With the aid of a controller, reversal points can be predefined in an arbitrary number and/or position in the separating region on the supply of loose bristle filaments, and as a result the separating of bristle bundles from the supply of loose bristle filaments can be adapted to requirements.

In order to achieve the object, a separating device for separating bristle bundles from a supply of loose bristle filaments is also proposed, which has the means and features of the independent claim directed toward a separating device of this type. According to the invention, the separating device has a bundle separator having at least one separating notch, a bristle magazine for a supply of loose bristle filaments, and a drive device which is specified to move the bundle separator having the at least one separating notch in a separating movement through a separating region on the supply of loose bristle filaments in such a way that the separating notch changes its direction of movement in the separating region at least twice, preferably at least thrice. In this way, a separating device which can be utilized for carrying out the method explained above, and thus for particularly reliably separating bristle bundles from the supply of loose bristle filaments, is achieved. The separating device can be specified to carry out, in particular by way of the drive device, the method as claimed in one of the claims directed toward such a method.

The drive device can comprise a drive motor and a gearbox. The drive motor can be connected to the bundle separator by way of the gearbox. The gearbox can be specified to convert a movement of an output shaft of the drive motor into a movement of the bundle separator and its separating notch. The drive motor of the drive device of the separating device can be a drive motor of a brush filling machine which is equipped with the separating device.

In one embodiment of the separating device it is provided that the gearbox has a control curve. The control curve can predefine the separating movement of the bundle separator and thus the separating movement of the separating notch and be operatively connected for driving purposes to the drive motor of the drive device. The control curve can be disposed or formed on a curve carrier, for example on a so-called double eccentric, which can be designed as a cam disk. The double eccentric can be part of the gearbox and be at least indirectly driven by the drive motor of the drive device.

The control curve can be designed in such a way that a rotation of the control curve about a rotation axis is transmitted to the bundle separator by way of a mechanical connection which can comprise a drive linkage. The control curve can be designed in such a way that the separating notch changes its direction of movement at least twice, preferably at least thrice, when the separating movement is carried out in the separating region on the supply of loose bristle filaments.

The mechanical connection can comprise a tappet element, for example a roller. The tappet element can be connected to the bundle separator by way of the drive linkage already mentioned. In this instance, a movement of the control curve can be transmitted to the bundle separator by way of the tappet element and the drive linkage.

In one embodiment of the separating device, the gearbox of the drive device comprises a con-rod mechanism by way of which at least part of the separating movement, in particular the main movement mentioned above, of the separating notch can be caused.

The gearbox can have an actuator, for example a piezo element, which is specified to cause an additional movement, for example the additional movement already mentioned above, of the separating notch. In this embodiment of the separating device, this actuator can then effect at least one of the at least two, preferably three, changes of the direction of movement of the separating notch in the separating region on the supply of loose bristle filaments.

The actuator can be specified to adjust the length of a drive linkage of the gearbox which is connected to the bundle separator. The actuator herein can be disposed in the force flux between the drive motor and the bundle separator. The actuator can be combined with a control curve as well as with a con-rod mechanism.

The drive device can have a preferably programmable controller which is specified to control the drive motor and/or the actuator. The controller can be programmed and/or specified in such a manner that the separating notch changes its direction of movement at least twice, preferably at least thrice, when the separating movement in the separating region is carried out. The separating device can thus be specified to carry out, by way of the controller, the method for separating bristle bundles according to one of the claims directed toward such a method.

Furthermore, an adaptation of the frequency and/or amplitude of the previously mentioned additional movement and/or main movement of the separating notch can be performed by the controller. This controller preferably has a data interface for connecting to a data storage, in particular to a cloud-based data storage. Furthermore, the controller can be programmable. In this way, the number and/or position of reversal points of the separating movement in the separating region on the supply of loose bristle filaments can be predefined, for example.

Control programs can be accessed by way of the data interface, and the separating movement of the separating notch can be influenced in this way. In particular when the separating device is used in a networked production environment, it is also possible to store control programs and/or operating parameters in the data storage and to make them available there to other separating devices by way of this data interface as required. This enables efficient control of a networked production environment which comprises a plurality of separating devices which can potentially even be operated so as to be distributed across different sites.

In one embodiment of the separating device, the bundle separator is designed as a circular arc separator and can be pivoted about a pivot axis in order to carry out the separating movement. In another embodiment of the separating device, the bundle separator is designed as a separating slide. For carrying out the separating movement, the separating slide can be moved in an alternating linear movement. In a further embodiment of the separating device, the bundle separator designed as a separator disk. The separator desk can be pivoted or rotated about a pivot axis in order to carry out the separating movement. In particular in the case of a bundle separator designed as a separator disk, the at least one separating notch can carry out an even number of changes in movement when the separating movement is carried out in the separating region on the supply of loose bristle filaments.

In order to achieve the object, a brush filling machine having a separating device having one or more of the features disclosed herein directed toward such a separating device is also proposed, which furthermore has a filling device with a filling tool which is specified to fill bristle bundles provided by the separating device into a bristle carrier of a brush.

The filling device and the separating device can be driven by a common drive motor. In this instance, the drive motor can also be referred to as the drive motor of the separating device, or as the drive motor of the filling device.

An output shaft of the drive motor and the filling tool can be connected to one another by way of an eccentric. A rotation of the output shaft can be converted into an alternating movement of the filling tool by way of the eccentric. The output shaft of the drive motor can function as the main shaft of the brush filling machine, the movement thereof being able to be transmitted to the filling tool by way of the eccentric, and to the bundle separator and the separating notch by way of the gearbox of the separating device already mentioned above.

### BRIEF DESCRIPTION OF THE DRAWINGS

The invention will be explained in more detail hereunder by means of exemplary embodiments but is not limited to these exemplary embodiments. Further exemplary embodiments are derived by combining the features of individual or of a plurality of claims with one another and/or by combining individual or a plurality of features of the exemplary embodiments. In the figures:

FIG. 1 shows a perspective view of a brush filling machine having a filling device which has a filling tool, and having a separating device of which the bundle separator has a separating notch and which is connected to a drive motor by way of a con-rod mechanism, said drive motor simultaneously also serving as the drive of the filling tool;

FIG. 2 shows a perspective view of a brush filling machine, the construction of which is similar to that of the brush filling machine shown in FIG. 1, wherein provided here in the powertrain between the bundle separator of the separating device and the drive motor is an actuator which is specified to adjust the length of a drive linkage in order to superimpose the main movement of the bundle separator with an additional movement;

FIG. 3 shows a perspective view of the brush filling machine shown in FIG. 2, wherein here the actuator which is disposed in the powertrain between the bundle separator and the drive motor has adjusted the length of the drive linkage, and the separating notch formed on the bundle separator has been advanced in the direction of the filling tool in comparison to the position shown in FIG. 2 within the separating region on the supply of loose bristle filaments;

FIG. 4 shows the brush filling machine shown in FIGS. 2 and 3, having a separating notch which has been further advanced;

FIG. 5 shows a perspective illustration of a brush filling machine, the separating device of which has, instead of a con-rod mechanism, a control curve on a double eccentric, by way of which the movement of the bundle separator can be effected according to the method according to the invention;

FIG. 6 shows the brush filling machine shown in FIG. 5, wherein provided here in the powertrain between the bundle separator and the drive motor is an actuator for adjusting the length of the drive linkage connected to the bundle separator;

FIG. 7 shows the brush filling machine shown in FIG. 6, having a drive linkage extended by the actuator in comparison to FIG. 6, and having a correspondingly displaced separating notch;

FIG. 8 shows the brush filling machine shown in FIG. 7, having a drive linkage which is extended in comparison to FIG. 7;

FIG. 9 shows an illustration for visualizing the separating movement of a bundle separator, designed as a separating slide, and its separating notch in the separating region on a bristle magazine having a supply of loose bristle filaments, wherein the illustrations in column A show a separating movement of the separating notch without a multiple change of direction of the separating notch, and the illustrations in column B show a separating movement of the separating notch with a triple change of direction of the separating notch in the separating region;

FIG. 10 shows a diagram which visualizes a separating movement of a separating notch with only one change of direction in the separating region, and in which a pivoting angle of the bundle separator (Y-axis) is plotted over a rotating angle of an output shaft of the drive motor (X-axis) of the brush filling machine shown in the previous figures; and

FIG. 11 shows a diagram which visualizes the separating movement of a separating notch with three changes of direction in the separating region on a supply of loose bristle filaments.

### DETAILED DESCRIPTION

In the description of the figures hereunder, functionally equivalent elements of the objects described are provided with the same reference signs, even in the case of a different design or shape.

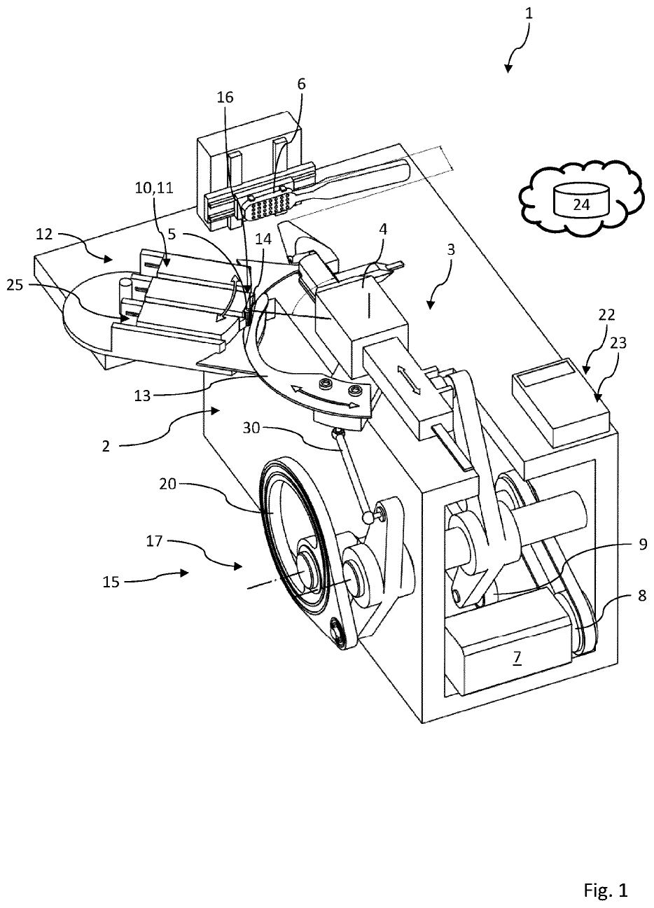

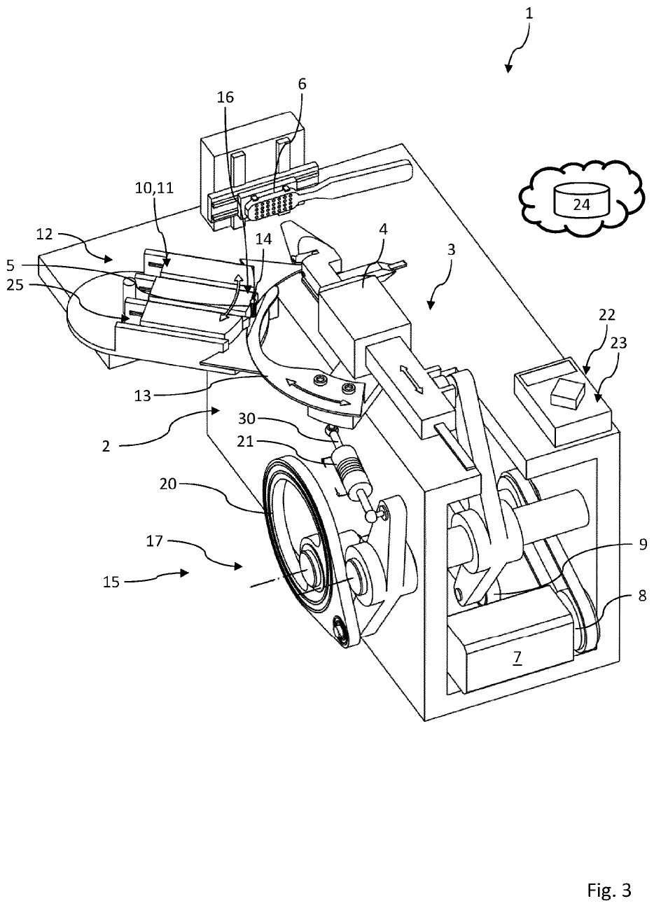

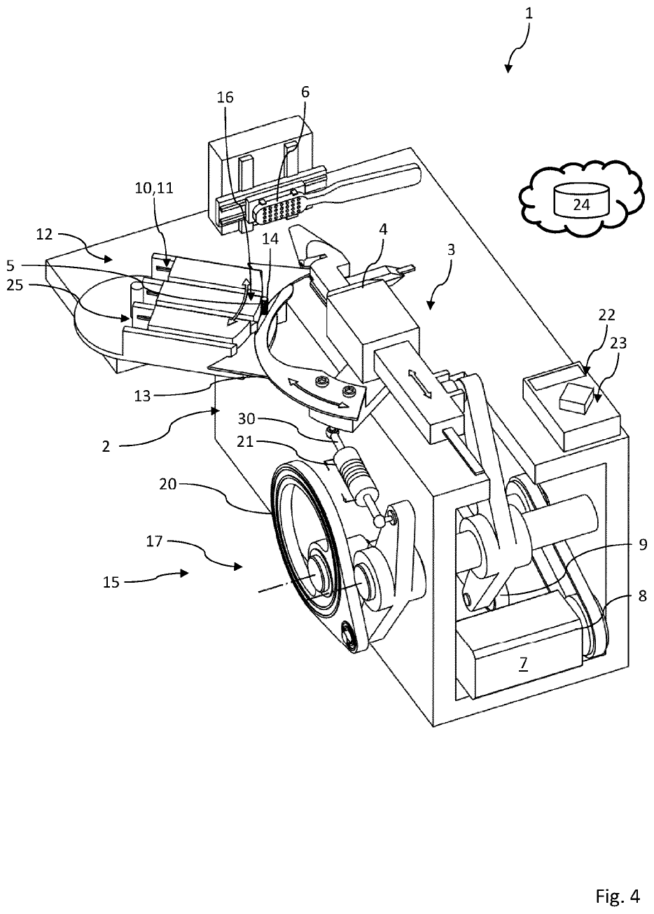

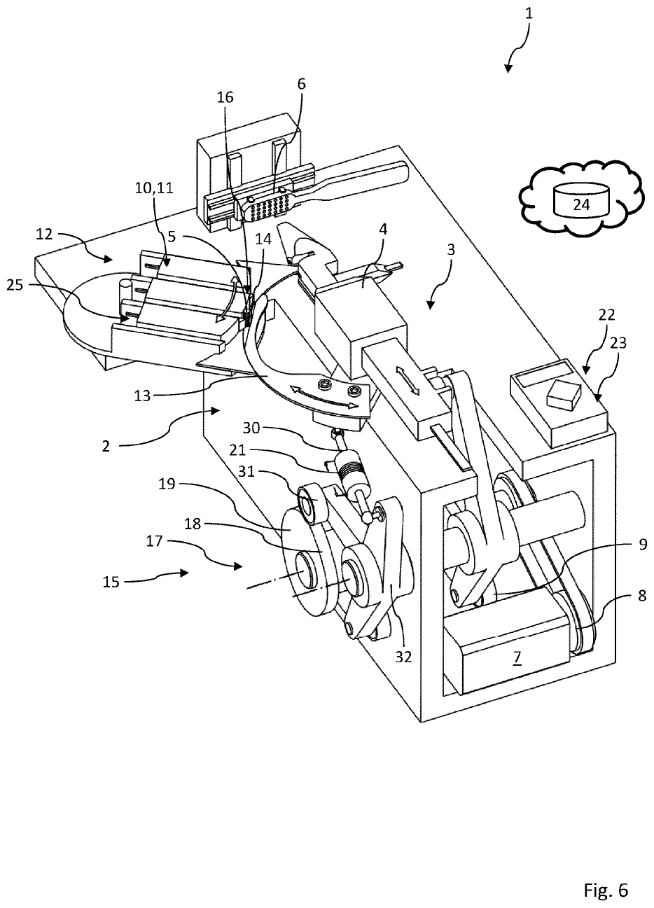

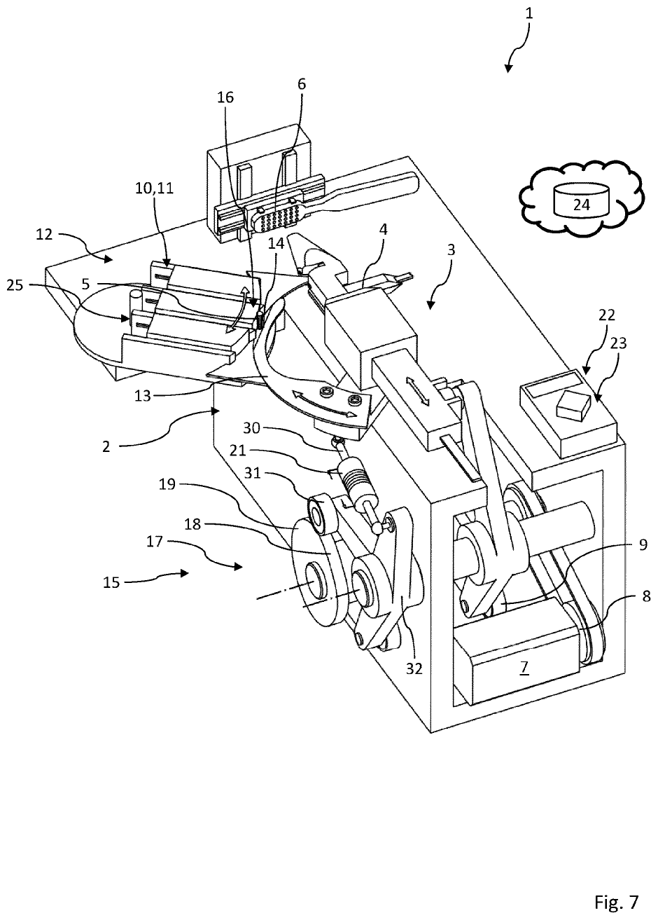

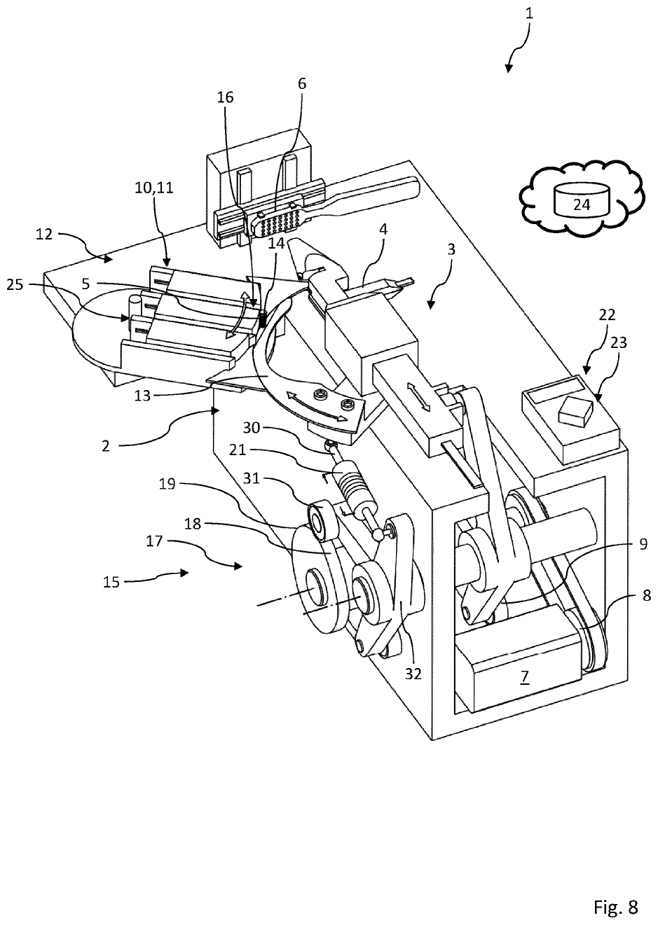

FIGS. 1 to 8 show different brush filling machines which as an entity are in each case denoted by the reference sign 1. Each of the brush filling machines 1 shown has a separating device 2 and a filling device 3 having a filling tool 4 which is specified to fill bristle bundles 5 provided by the separating device 2 into a bristle carrier 6 which is clamped on the brush filling machine 1.

The filling tool 4 and the separating device 2 are operatively connected for driving purposes to a common drive motor 7 of the brush filling machine 1. In this way, the filling tool 4 and the separating device 2 can be driven by way of the common drive motor 7. The drive motor 7 can thus be referred to as the drive motor of the separating device 2, and also as the drive motor of the filling device 3 and of the filling tool 4.

In all the brush filling machines 1 shown in the figures, an output shaft 8 of the drive motor 7 is operatively connected for driving purposes to the respective filling tool 4 of the filling device 3 by way of an eccentric 9.

The separating device 2 serves to separate bristle bundles 5 from a supply 10 of loose bristle filaments 11. The supply 10 of loose bristle filaments 11 is disposed in a bristle magazine 12 of the respective separating device 2. The bristle magazine 12 can also be referred to as a material box and has three material ducts 25 in each of which one variety of bristle filaments 11 can be disposed.

Each separating device 2 has a bundle separator 13 having a separating notch 14, a bristle magazine 12 for the supply 10 of loose bristle filaments 11, and a drive device 15. The drive device 15 is specified to move the bundle separator 13 having the separating notch 14 in a separating movement through a separating region 16 past the supply 10 of loose bristle filaments 11 in such a way that the separating notch 14 in the separating region 16 changes its direction of movement at least twice, preferably at least thrice. This facilitates reliable filling of the separating notch 4 with loose bristle filaments 11 for separating bristle bundles 5 from the supply 10.

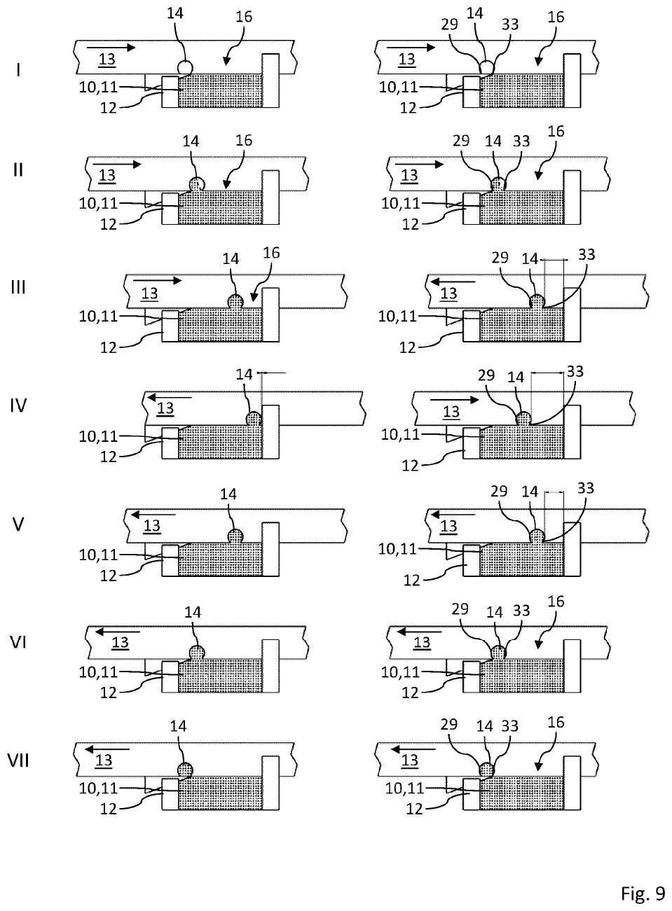

The bundle separators 13 shown in FIGS. 1 to 8 are circular arc separators which are pivotable about a pivot axis. The bundle separators 13 shown in FIG. 9 are linearly displaceable separating slides.

The drive device 15 of the separating device 2 has as a drive motor the drive motor 7 of the brush filling machine 1, and a gearbox 17 by way of which the drive motor 7 is operatively connected for driving purposes to the bundle separator 13 of the separating device 2.

The gearbox 17 is specified to convert a movement of the output shaft 8 of the drive motor 7 into the previously mentioned separating movement. The separating devices 2 shown in FIGS. 1 to 8 differ from one another in particular in terms of the embodiment of their respective gearbox 17.

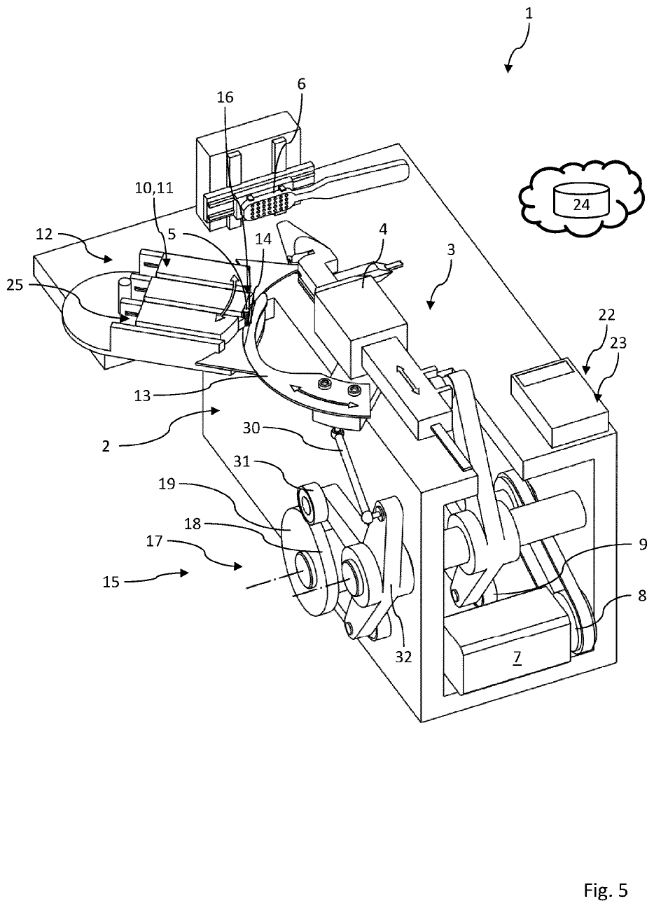

The separating devices 2 shown in FIGS. 5 to 8 have a gearbox 17 having a control curve 18 which is formed on a double eccentric 19. The double eccentric 19 serves as a curve carrier. The control curve 18 herein predefines the separating movement of the bundle separator 13 and of the separating notch 14, and also the previously mentioned changes of direction of the separating notch 14 in the separating region. The drive motor 7 is operatively connected for driving purposes to the double eccentric 19, and as a result also to the control curve 18. The bundle separator 13 is connected to a drive linkage 30. The movement of the control curve 18 can be transmitted to the drive linkage 30 and from the latter to the bundle separator 13 by way of a tappet element 31, presently a roller, and a transmission lever 32.

The separating devices 2 shown in FIGS. 1 to 4 have a gearbox 17 which in each case comprises a con-rod mechanism 20 by way of which at least part of the separating movement, in particular the main movement, already mentioned above, of the bundle separator 13 and its separating notch 14 can be caused.

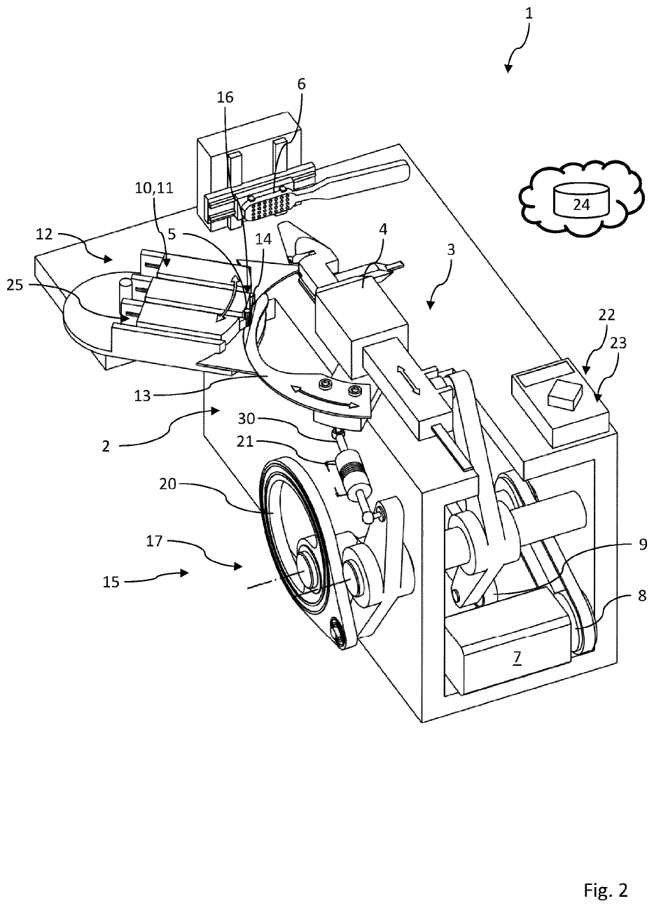

In the separating devices 2 shown in FIGS. 2 to 4 and 6 to 8, the respective gearbox 17 moreover has an actuator 21, specifically a piezo element, which is specified and provided to carry out an additional movement of the separating notch 14. With the aid of the actuator 21 it can be effected that the separating notch 14 on the bundle separator 13 in the separating region 16 changes its direction of movement when the separating movement is carried out.

The actuators 21 shown in the figures are in each case specified to adjust the length of a drive linkage 30 of the gearbox 17 that is connected to the respective bundle separator 13. The actuators 21 are disposed in the force flux between the drive motor 7 and the respective bundle separator 13.

The brush filling machines 1 shown in each of FIGS. 1 and 5 have in each case a controller 21 which is specified to control the respective drive motor 7. The drive device 15 of the separating devices 2 according to FIGS. 2 to 4 and 6 to 8 are equipped with a controller 22 which is specified to control the drive motor 7 and the respective actuator 21.

Each of the controllers 22 shown in the figures possesses a data interface 23 for connecting to a data storage 24, in particular to a cloud-based data storage.

Control programs and/or operating parameters for operating the separating device 2, the filling device 3 and the brush filling machine 1 overall can be accessed from the data storage 24 by way of the data interface 23, or can be stored in the data storage 24 for other brush filling machines 1, separating devices 2, or filling devices 3 and their controllers 22, respectively. The data interface 23 of the respective controller 22 is thus designed as a bidirectional data interface 23.

Each separating device 2 shown in the figures is specified to carry out the following method for separating bristle bundles 5 from a supply 10 of loose bristle filaments 11.

In the process, a bundle separator 13, by way of its separating notch 14, is moved in a separating movement past the supply 10 of loose bristle filaments 11. In the process, a bristle bundle 5 is separated from the supply 10, as a result of which the bristle bundle 5 which consists of a number of loose bristle filaments 11 makes its way into the separating notch 14.

When carrying out the separating movement in the separating region 16 on the supply 10, the separating notch 14 is moved in such a way that it changes its direction of movement at least twice, preferably at least thrice, in the separating region 16.

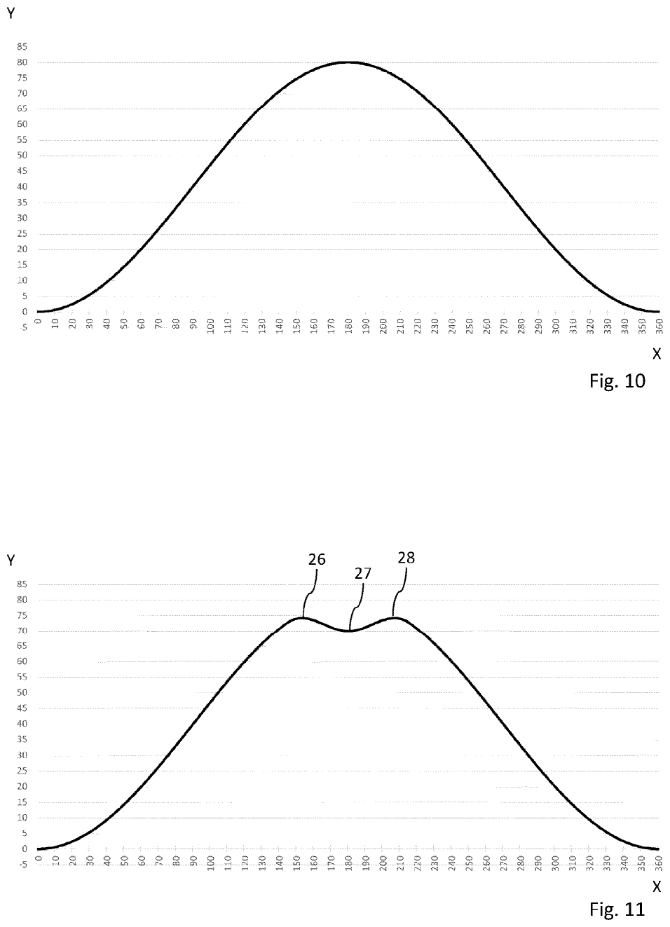

FIG. 11 shows a diagram in which the angular position of the bundle separator 13, and thus the position of the separating notch 14, relative to the supply 10 of loose bristle filaments 11 is plotted over a rotating angle of the output shaft 8 of the drive motor 7. A comparison with the diagram from FIG. 10 makes clear that the separating notch 14 changes its direction of movement thrice when the separating movement is carried out according to the curve from FIG. 11 in the separating region 16 on the supply 10. The illustrations in column B from FIG. 9 also visualize a comparable separating movement.

Reversal points 26, 27, 28 of the separating notch 14 in the separating region 16 on the supply 10 can also be seen by means of the curve from FIG. 11. The two maximums of the curve 11 highlight rear reversal points 26 and 28 of the separating notch 14 in the separating region 16, which are already reached at an angular position of the bundle separator 13 of somewhat less than 75°. The minimum of the curve between the reversal points 26 and 28 represents a front reversal point 27 which is passed by the separating notch 14 when the separating movement is carried out.

In comparison, FIG. 10 shows that the separating movement of the bundle separator 13 carried out according to the curve from FIG. 10 leads the separating notch 14 only to one rear reversal point which however is reached only once the bundle separator 13 has already been pivoted by 80°.

FIG. 11 thus shows that the method according to the invention and the associated separating movement of the bundle separator 13 enable a reduction of the separating region 16 on the supply 10 of loose bristle filaments 11 in which the separation of bristle bundles 5 takes place, without reducing the time which the separating notch 14 spends in the separating region 16. In this way, more compact bristle magazines 12 can be used, or else bristle magazines 12 which have a larger number of material ducts 25 which are then correspondingly narrower.

When carrying out the separating movement, the separating notches 14 in all separating devices 2 shown in the figures can pass at least two, three or optionally also a plurality of reversal points 26, 27, and 28. According to the illustrations in column B of FIG. 9, and also according to FIG. 11, the separating notches 14 in the method carried out on the separating devices 2 pass a total of three reversal points 26, 27 and 28 which are in each case disposed in the separating region 16 on the supply 10 of loose bristle filaments 11, and optionally at different positions. The separating movement which is carried out by the separating notch 14 in this instance has a sinusoidal profile and can be understood to be two, in each case sinusoidal, movements superimposed on one another.

FIG. 11 shows that, when the separating movement is carried out, the separating notch 14 passes two rear reversal points 26 and 28 which in each case face away from the filling tool 4 of the respective filling device 3 and can be disposed at different positions in the separating region 16 on the supply 10. The separating movement of the separating notch 14 visualized in FIG. 11 can be generated by superimposing at least two movements which can in each case be sinusoidal and/or have different amplitudes. It is also possible for the separating movement of the separating notch 14 to be composed of at least two movements which are carried out successively and, for example, are sinusoidal and/or have different amplitudes.

A first movement of the at least two movements herein can be a main movement of the separating notch 14, by way of which the separating notch 14 is moved between the filling tool 4, already mentioned above, of the respective brush filling machine 1 and the supply 10 of loose bristle filaments 11, which is disposed in the bristle magazine 12 of the respective separating device 2. The separating notch 14 can be moved into the separating region 16 and also be removed from the separating region 16 again by the main movement.

A second movement of the at least two movements can be an additional movement of the separating notch 14, which the separating notch 14 carries out within the separating region 16 on the supply 10, and thus on the bristle magazine 12. The main movement of the separating notch 14 can be caused by the drive motor 7, already mentioned above, and in particular by a rotation of its output shaft 8.

The additional movement of the separating notch 14 can be caused by the actuator 21, already mentioned above, or optionally also by the drive motor 7.

The frequency and/or the amplitude of the additional movement and/or of the main movement herein can be predefined by a preferably programmable controller 22, as the brush filling machines 1 shown in the figures for the separating devices 2, the filling devices 3 and the actuation of the drive motor 7 have in each case. The brush filling machines 1 shown in the figures are specified to access, by way of the data interface 23 already mentioned above, control programs and/or operating and production parameters for activating the individual functional units of the brush filling machine 1, thus of the separating device 2 and the filling device 3. Control programs, operating and production parameters for other brush filling machines 1, which are operated in a networked production environment, and their separating devices 2 and filling tools 3 can also be stored in the data storage 24 by way of the data interfaces 23.

The illustration from FIG. 9 shows a bundle separator 13 which is designed as a linearly movable separating slide and has a separating notch 14. The arrows which are in each case assigned to the reference sign 13 of the bundle separator in FIG. 9 visualize the direction of movement of the bundle separator 13 in the individual phases of the separating movement, which are illustrated in lines I to VII of FIG. 9.

The illustrations from column A in FIG. 9 visualize a separating movement in which the bundle separator 13 and its separating notch 14 changes its direction of movement only once in the separating region 16.

According to column A, line I, the separating notch 14 enters the separating region 16 on the bristle magazine 12 with the supply 10 of loose bristle filaments 11. According to column A, line II, the movement of the bundle separator 13, and thus the movement of the separating notch 14, through the separating region 16 is continued until the separating notch 14 reaches its only rear reversal point shown in column A, line IV by way of the intermediate position visualized in column A, line III.

Proceeding from the position in column A, line IV, the separating notch 14 is then moved out of the separating region 16 on the supply 10 again by way of the positions shown in column A, lines VI and VII.

The illustrations from column B in FIG. 9 show a separating movement of the separating notch 14 in which the separating notch 14 changes its direction of movement thrice in the separating region 16.

According to column B, line I, the separating notch 14 here too enters the separating region 16 on the bristle magazine 12. Column B, line II shows that loose bristle filaments 11 make their way into the separating notch 14 by way of an edge 29 of the separating notch 14 that is a rear edge 29 in the direction of movement of the separating notch 14 through the separating region 16. If the direction of movement of the separating notch 14 is reversed, the filling of the separating notch 14 takes place by way of a second edge 33 of the separating notch 14 that is opposite the first edge 29.

According to column B, line III, the separating notch 14 has reached its first rear reversal point 26. Proceeding from this first rear reversal point 26, the separating movement of the separating notch 14 is continued in the opposite direction, as a result of which the separating notch 14 makes its way into the position shown in column B, line IV, in which the separating notch 14 has reached its front reversal point 27 in the separating region 16.

From this front reversal point 27, the separating notch 14 is then moved to the second rear reversal point 28. The separating notch 14 has then reached the rear reversal point 28 in the illustration according to column B, line V.

From this rear reversal point 28, the separating notch 14 is then moved out of the separating region 16 on the supply 10 of loose bristle filaments 11 by way of the position shown in FIG. 9, column B, lines VI and VII.

Shown in column B, line III of FIG. 9 is the first and thus also rearmost reversal point 26 of the two rear reversal points 26 and 28 which the separating notch 14 passes when the method is carried out.

In comparison, FIG. 9, column A, line IV shows that the separating notch 14 has been significantly moved onward in the rear reversal point depicted therein.

A comparison of the illustration from column A, line III of FIG. 9 and the illustration from column B, line IV of FIG. 9 thus makes clear that the proposed method in which the separating notch 14 changes its direction of movement at least twice, preferably at least thrice, in the separating region 16 enables a reduction in the width of the separating region 16.

### LIST OF REFERENCE SIGNS

1 Brush filling machine
2 Separating device
3 Filling device
4 Filling tool
5 Bristle bundle
6 Bristle carrier
7 Drive motor
8 Output shaft
9 Eccentric between 8 and 7
10 Supply
11 Bristle filaments
12 Bristle magazine
13 Bundle separator
14 Separating notch
15 Drive device
16 Separating region
17 Gearbox
18 Control curve
19 Double eccentric
20 Con-rod mechanism
21 Actuator
22 Controller
23 Data interface
24 Data storage
25 Material duct
26 First rear reversal point
27 Front reversal point
28 Second rear reversal point
29 First edge of 14
30 Drive linkage
31 Tappet element, roller
32 Transmission lever
33 Second edge of 14

1. A method for separating bristle bundles (5) from a supply (10) of loose bristle filaments (11), the method comprising:
moving a bundle separator (13) having a separating notch (14) in a separating movement past the supply (10) of loose bristle bundles (11), and in the process separating a bristle bundle (5) from the supply (10) and the bristle bundle (5) making its way into the separating notch (14), and
when the separating movement is carried out, changing a direction of movement of the separating notch (14) in a separating region (16) on the supply (10) at least twice.

2. The method as claimed in claim 1, further comprising, when the separating movement is carried out, the separating notch (14) passing at least two, reversal points (26, 27, 28) which are disposed in the separating region (16) on the supply (10) of loose bristle filaments (11).

3. The method as claimed in claim 1, further comprising, when the separating movement is carried out, the separating notch (14) passing at least two rear reversal points (26, 28) which face away from a filling tool (4) and are disposed at different positions in the separating region (16) on the supply (10).

4. The method as claimed in claim 1, further comprising generating the separating movement by superimposing at least two movements, or wherein the separating movement is composed of at least two movements which are carried out successively.

5. The method as claimed in claim 4, wherein at least one of a) a first movement of the at least two movements is a main movement of the separating notch (14), by which the separating notch (14) is moved between a filling tool (4) and the supply (10) of loose bristle filaments (11), or b) a second movement of the at least two movements is an additional movement of the separating notch (14), which the separating notch (14) carries out within the separating region (16) on the supply (10).

6. The method as claimed in claim 5, further comprising at least one of a) carrying out the main movement by a drive motor (7) of a separating device (2), or b) carrying out the additional movement by an actuator (21), which is disposed in a force flux between the bundle separator (13), on which the separating notch (14) is formed, and a drive motor (7) for the bundle separator (13).

7. The method as claimed in claim 5, further comprising predefining at least one of a frequency or amplitude of at least one of the additional movement or of the main movement by a controller (22).

8. A separating device (2) for separating bristle bundles (5) from a supply (10) of loose bristle filaments (11), the separating device (2) comprises:
a bundle separator (13) having at least one separating notch (14),
a bristle magazine (12) for a supply (10) of loose bristle filaments (11), and
a drive (15) configured to move the bundle separator (13) having the at least one separating notch (14) in a separating movement through a separating region (16) past the supply (10) of loose bristle filaments (11) such that the separating notch (14) changes a direction of movement in the separating region (16) on the supply (10) at least twice.

9. The separating device (2) as claimed in claim 8, wherein the separating device (2) is configured such that the bundle separator (13) having the separating notch (14) moves in a separating movement past the supply (10) of loose bristle bundles (11), and in the process separates the bristle bundle (5) from the supply (10) and the bristle bundle (5) then makes its way into the separating notch (14), and when the separating movement is carried out, the separating notch (14) changing its direction of movement in the separating region (16) on the supply (10).

10. The separating device (2) as claimed in claim 8, wherein the drive (15) comprises a drive motor (7) and a gearbox (17), wherein the drive motor (7) is connected to the bundle separator (13) by way of the gearbox (17), and the gearbox (17) is adapted to convert a movement of an output shaft (8) of the drive motor (7) into a movement of the bundle separator (13).

11. The separating device (2) as claimed in claim 10, wherein the gearbox (17) comprises a control curve (18) which is at least one of formed on a double eccentric (19) and predefines the separating movement or operatively connected for driving purposes to the drive motor (7).

12. The separating device (2) as claimed in claim 10, wherein the gearbox (17) comprises a con-rod mechanism (20) by way of which at least part of the separating movement of the separating notch (14) is adapted be caused.

13. The separating device (2) as claimed in claim 10, wherein the gearbox (17) comprises an actuator (21), in particular a piezo element, which is adapted to carry out an additional movement of the separating notch (14).

14. The separating device (2) as claimed in claim 13, wherein at least one of a) the actuator (21) is adapted to adjust a length of a drive linkage (30) of the gearbox (17) that is connected to the bundle separator (13), or b) the actuator (21) is disposed in the force flux between the drive motor (7) and the bundle separator (13).

15. The separating device (2) as claimed in claim 8, wherein the drive (15) has a controller (22) which is configured to control at least one of the drive motor (7) or the actuator (21).

16. A brush filling machine (1) comprising: the separating device (2) as claimed in claim 8, and having a filling device (3) with a filling tool (4) which is adapted to fill bristle bundles (5) provided by the separating device (2) into a bristle carrier (6).

17. The brush filling machine (1) as claimed in claim 16, wherein the filling device (3) and the separating device (2) are driven by a common drive motor (7).

18. The brush filling machine (1) as claimed in claim 17, wherein an output shaft (8) of the drive motor (7) and the filling tool (4) are connected by an eccentric (9).

19. The method as claimed in claim 1, wherein the separating movement has a sinusoidal profile.

20. The method as claimed in claim 4, wherein the at least two movements are at least one of sinusoidal or have different amplitudes.
